(19) United States
(12) Patent Application Publication
(10) Pub. No.: US 2017/0197859 A1
(43) Pub. Date: Jul. 13, 2017

(54) DEVICE FOR MELTING GLASS COMPRISING A FURNACE, A CHANNEL AND A BARRIER

(71) Applicant: SAINT-GOBAIN ISOVER, Courbevoie (FR)

(72) Inventors: Richard CLATOT, Fleurines (FR); Stephane MAUGENDRE, Precy sur Oise (FR); Francois SZALATA, Laigneville (FR)

(73) Assignee: SAINT-GOBAIN ISOVER, Courbevoie (FR)

(21) Appl. No.: 15/324,022

(22) PCT Filed: Jul. 1, 2015
(86) PCT No.: PCT/FR2015/051809

§ 371 Date: Jan. 5, 2017

(30) Foreign Application Priority Data
Jul. 8, 2014 (FR) 1456580

(51) Int. Cl. C03B 5/182; C03B 5/185; C03C 13/06; C03C 3/091; C03C 3/078; C03C 3/087; C03C 3/089; C03B 5/03; C03C 3/062

(52) U.S. Cl. CPC C03B 5/182; C03B 5/03; C03B 5/185; C03C 13/06; C03C 3/062; C03C 3/078; C03C 3/087; C03C 3/089; C03C 3/091; C03C 2213/00

(57) ABSTRACT

A device for melting glass includes a furnace equipped with electrodes in contact with the mass of vitrifiable materials. The furnace includes a side opening connected to a feeder channel for the molten glass, a removable barrier dipping into the glass in or before the opening so that a vertical plane passing through the upstream face of the barrier touches the biggest horizontal circle which can be inscribed the furthest downstream in the furnace, barrier excluded, the biggest circle being at the height of the highest side of the bottom of the channel. The device delivers a glass of good quality which can feed a fiberizing device.

The invention relates to a device for the melting of glass comprising a cold crown electric furnace for the preparation of molten glass.

The device according to the invention comprises an electric furnace provided with electrodes in contact with the mass of vitrifiable materials, a channel connecting the furnace to a device for transformation of the molten glass, and a barrier which dips into the glass, preventing the nonmolten and floating starting material from passing through the channel and proceeding up to the device for transformation of the glass. In this type of device, the barrier is normally placed in the channel. However, it had been noticed that the barrier could retain congealed glass for subsequent uncontrolled release in the form of solid particles into the molten glass. Such behaviour is harmful to the quality of the glass produced, in particular when the latter has to feed fiberizing bushings. In order to overcome this defect, the idea arose of placing the barrier not in the channel but further upstream, immediately at the outlet of the furnace. At this place, the glass is hotter and is the site of convection currents, these two factors preventing the formation of congealed glass on the barrier. The quality of the glass is thus found to be thereby improved.

The furnace used in the context of the invention is a “cold crown” furnace which makes it possible to melt vitrifiable materials via the heat given off by the Joule effect from electrodes dipping into the vitrifiable materials. The solid composition of vitrifiable materials is introduced via the top and forms an upper layer, also known as crust, completely covering the bath of molten materials. According to the prior art, the molten materials are extracted via the bottom or side via a throat in order to pass through a feeder channel which feeds the fiberizing devices. Fiberizing can take place continuously directly after the melting of the vitrifiable materials. When a throat is used between the furnace and the feeder channel, rapid wear of the refractories delimiting the throat, in particular the upper part of the latter is observed. This is because, despite the use of cooling systems which make it possible to limit the attack on the refractories by the molten materials at high temperature, these refractories generally have to be replaced more rapidly than the other refractory components of the furnace. In addition, such a replacement requires that the furnace be shut down. Furthermore, a throat is more readily subject to the formation of a plug when the furnace is put in sleep mode for maintenance or in the event of a power cut. The removal of the plug of solidified glass is often impossible and often requires the destruction and reconstruction of the throat.

Manufacturing of this type generally operates with draws of between 5 and 100 tonnes per day. It is the passage of the glass through the fiberizing bushings which limits the draw. The conversion into fibres is thus the determining stage of the glass stream through the whole of the process (draw). This type of furnace with relatively modest dimensions (bottom internal surface area between 1 m² and 30 m²) is very flexible and can be easily shut down at any moment according to circumstances. It can generally operate continuously for between 24 hours and 6 months, and even longer.

U.S. Pat. No. 6,314,760 teaches a circular furnace having electrodes and having a conical bottom feeding a feeder channel, the glass stream between the furnace and the channel passing through a molybdenum pipe surrounded by a casing through which cooling water passes.

U.S. Pat. No. 3,912,488 teaches a circular furnace having electrodes and having a conical bottom comprising an orifice for extraction of the molten materials at the apex of the cone of the bottom, said orifice being cooled by a circulation of water.

WO2013098504 teaches a process for the manufacture of mineral fibres, the stream of molten glass former between the furnace and the feeder channel passing under a height-adjustable metal barrier comprising a casing cooled by a stream of cooling fluid. Adjusting the height of the barrier makes it possible to influence the temperature of the glass to be fiberized in order to bring it into the viscosity range desired for the fiberizing. The height of the barrier regulates only the temperature and not the flow rate of glass.

US2002/0000101 teaches a device for the melting of glass comprising a circular furnace equipped with an opening consisting of a molybdenum pipe.

WO2004/052054 teaches a furnace equipped with electrodes comprising a barrier dipping into the glass and held only by the crown. This barrier is not removable.

U.S. Pat. No. 2,559,683 teaches a removable barrier placed in a refining zone. The barrier serves only to retain floating nonmolten starting material in the furnace. The refining zone is as deep as the furnace.

GB 714 292 teaches a barrier separating two zones of a furnace, a melting zone and a refining zone. The glass is heated on either side of the barrier and the hot spot of the glass is located opposite the downstream face of the barrier. The barrier serves only to retain the floating nonmolten starting material in the furnace.

The invention relates first to a device for melting glass comprising a furnace equipped with electrodes in contact with the mass of vitrifiable materials, the said furnace comprising a side opening connected to a feeder channel for the molten glass, a removable barrier dipping into the glass in the furnace. In the channel, and already from its passage under the barrier, the glass is preferably in plug flow, without return convection current. The channel is sufficiently shallow to prevent return currents. The barrier dips sufficiently deeply into the glass for the glass which has passed under it not to participate in a return current towards the furnace.

According to the invention, the barrier is close to the opening, in the furnace in front of the opening or in the opening and, in this case, immediately at the outlet of the furnace. If the biggest horizontal circle which can be inscribed in the furnace, barrier excluded, and the furthest in its downstream is considered, then a vertical plane passing through the upstream face of the barrier touches this circle. This circle is taken in the horizontal plane passing through the highest side of the bottom of the channel. The barrier is not taken into account in accommodating this circle, hence the expression “barrier excluded”. In particular, the barrier is preferably in the furnace and in front of the opening, supported against the side walls of the furnace on either side of the opening. The barrier is then wider than the opening of the furnace. The refractories on either side of the opening can be described as “jamb” and they constitute good supports for the downstream face of the barrier. If the upstream face of the barrier is not vertical but slightly inclined with respect to the vertical, it is sufficient for there to exist at least one vertical plane passing through the upstream face of the barrier and touching this circle defined above for the condition with regard to the position of the barrier according to the invention to be fulfilled. Whether the barrier is in the furnace or in the inlet of the channel, it is preferable for it to be in contact with refractory side walls, in particular the side walls of the furnace or those of the channel, so that the glass going through the channel is forced to pass under the barrier and cannot pass through the sides. This advantageously prevents the passage into the channel of nonmolten starting material. As already said, the barrier is advantageously in the furnace.

The positioning of the barrier according to the invention is ideal for preventing depositions of nonmolten glass on the barrier as a result of its proximity to the electrodes, the said barrier being in a hotter region than in the channel, and owing to the fact that it is in convection movements of the molten glass in the furnace. The use of the removable barrier according to the invention makes it possible to operate in stop & go mode, that is to say that it is possible to shut down the device and to restart it without having to fracture refractories in order to bring it back into operation. The fact that the barrier is in the melting region makes it possible to develop a convection recirculation between the electrodes and the walls of the furnace, barrier included. Modelling has shown that convection recirculation was insufficient when the barrier is too far into the channel.

The opening of the furnace used for the casting of the glass via the channel is lateral, which means that it occurs in the side wall of the furnace, the said wall generally being vertical.

The barrier can be made of steel and cooled with a fluid, such as air or water. It can also be made of molybdenum, of an alloy of refractory metals, of ceramic, of platinum, of ceramic or refractory coated with platinum, of alloy of refractory metals which is coated with platinum or of molybdenum coated with platinum, it being understood that, with these materials, it may be noncooled or cooled with an internal stream of a cooling fluid, such as air or water.

The barrier retains the floating nonmolten raw materials in the furnace. The barrier is removable at least vertically. Its ability to be mobile vertically gives the possibility to adjust its height. Generally, it is dipped into the glass with a height h1 from the bottom of the crust of raw materials, h1 preferably being at least 150 mm. The raw materials crust generally has a thickness of between 80 and 350 mm. The height h2 of glass under the barrier is preferably at least 100 mm. Preferably, the height of glass h2 under the barrier is less than the height h1 of the barrier in contact with the molten glass under the crust of raw materials. This position of the barrier results in an increase in the residence time of the molten glass in the furnace, which is favourable to the reduction, indeed even the disappearance, of the nonmolten particles mixed with the molten glass. The barrier is advantageously removable laterally, which facilitates the detachment thereof from the side wall of the furnace against which it is in contact. Its ability to be mobile laterally allows its detachment from the side wall of the furnace. The position of the barrier into the furnace, supported against the side walls of the furnace on either side of the opening, allows lateral mobility.

Seen from the top, the furnace can have a polygonal, in particular square or rectangular, shape or can be circular. The bottom of the furnace can be flat or can comprise an inclined surface. The inclined surface of the bottom makes it possible to carry the molten glass former towards the bottommost point of the bottom at the beginning of melting. This is because it is advantageous to collect the small volume of molten glass former at the start of the filling of the furnace in order to form a hot spot which accumulates the heat. This makes it possible to proceed faster at the start of filling and in a way to initiate the operation of the furnace. The inclined surface can be that of an inverted cone, the apex of which is the bottommost point of the bottom of the furnace. It can also be an inclined plane, the intersection of which with the cylindrical wall of the furnace constitutes a curved line, which exhibits a point which is the bottommost of the bottom. Other forms are possible. Preferably, the electrodes are close to the place where the raw materials are introduced. Thus, if the latter are capable of being introduced successively at several places, provision is advantageously made to be able to move the electrodes in order to be able to make them follow the place of introduction of the raw materials.

The interior of the furnace is provided with refractories which come into contact with the vitrifiable materials, both at the bottom and at the side wall. The side wall generally comprises an external metal casing in contact with the ambient air. This metal casing generally comprises two partitions between which circulates a cooling fluid, such as cooling water.

Electrodes are in contact with vitrifiable materials in order to heat them by the Joule effect. The electrodes can arrive in the glass through the bottom or can be immersed via the top. These electrodes generally comprise a part made of molybdenum in contact with the vitrifiable materials. For the case of electrodes immersed in the glass via the top, they can in addition comprise a part made of steel which is not in contact with the glass, above the vitrifiable materials, which are connected to an electric voltage. The introduction of the electrodes via the top exhibits several advantages with respect to the configuration according to which the electrodes would pass through the bottom. In particular, passing through the bottom requires the preparation of electrode blocks forming the connection between the electrode and the bottom, which blocks are particularly problematic to prepare owing to the fact that the bottom is also cooled by a metal casing. The number of electrodes is adjusted as a function of the size and the draw of the furnace.

The furnace is equipped with means for introducing the vitrifiable materials, which includes the cullet. These vitrifiable materials are generally in the form of powder, indeed even in the form of granules, generally up to a diameter of 10 mm, which means that more than 90% of the weight of the glass former is composed of particles, the two most distant points of each particle being less than 10 mm. The vitrifiable materials are homogeneously distributed over the entire internal surface of the furnace in order to form a crust covering the molten materials. Use may be made, as means for introducing the vitrifiable materials, of a batch charger which feeds the furnace via the top. The vitrifiable materials are ejected uniformly over the entire internal surface of the furnace. The not yet molten vitrifiable materials form a crust at the surface above the molten vitrifiable materials. This crust forms a heat shield which limits the heat losses via the top. The furnace is not generally equipped with means for stirring the vitrifiable materials (no mechanical stirrer or submerged burner), except possibly of the bubbler type.

The glass surface in the furnace in contact with the atmosphere of the furnace is generally between 1 and 30 m². In operation, the depth of vitrifiable materials (molten+nonmolten) is generally between 200 and 1000 mm and preferably between 300 and 800 mm, indeed even between 400 and 600 mm. The draw in operation of the device can generally be between 5 and 100 tonnes per day.

The feeder channel can comprise at least one orifice in its bottom. It can comprise 2 or 3 or more of them according to the number of transformation devices, in particular fiberizing devices, to be fed simultaneously. The thread of molten vitrifiable materials falling through this orifice can subsequently be directed towards a fiberizing machine. The glass flow in the channel is laminar.

The transformation into fibres can be carried out by an “internal centrifugation” device. The principle of the internal centrifugation process is well known in itself to a person skilled in the art. In outline, this process consists in introducing a thread of molten mineral material into a spinner, also known as fiberizing dish, rotating at high speed and pierced at its periphery by a very large number of orifices through which the molten material is ejected in the form of filaments under the effect of the centrifugal force. These filaments are then subjected to the action of an annular pull current at high temperature and high speed hugging the wall of the spinner, which current thins them and transforms them into fibres. The fibres formed are entrained by this gaseous pull current to a receiving device generally consisting of a belt permeable to gases. This known process has formed the subject of numerous improvements, including in particular those taught in European Patent Applications EP 0 189 534, EP 0 519 797 and EP 1 087 912.

The device according to the invention is suitable for the melting of all types of glass.

The device according to the invention can in particular be used to melt glass for fibres with the compositions described in one or other of the documents WO99/57073, WO99/56525, WO00/17117, WO2005/033032 and WO2006/103376. The ideal fiberizing temperature depends on the composition of the molten material.

Generally, the aim is for its viscosity to be between 25 Pa.s and 120 Pa.s.

Thus, the invention also relates to a process for the preparation of glass comprising the melting of vitrifiable materials by the device according to the invention. According to this process, the channel of the device can feed a glass wool fiberizing device.

The final glass can have a composition (composition A) comprising:

SiO₂: 35 to 80% by weight,

Al₂O₃: 0 to 30% by weight,

CaO+MgO: 5 to 35% by weight,

Na₂O+K₂O: 0 to 20% by weight,

it being understood that, in general,

SiO₂+Al₂O₃ is within the range extending from 50 to 80% by weight and that Na₂O+K₂O+B₂O₃ is within the range extending from 5 to 30% by weight.

The vitrifiable materials introduced can correspond to the composition of a glass wool (composition B) and can comprise:

SiO₂: 50 to 75% by weight,

Al₂O₃: 0 to 8% by weight,

CaO+MgO: 5 to 20% by weight,

Iron oxide: 0 to 3% by weight,

Na₂O+K₂O: 12 to 20% by weight,

B₂O₃: 2 to 10% by weight.

The vitrifiable materials introduced can also correspond to the composition of an alumina-rich glass wool (composition C) and can comprise:

SiO₂: 35 to 50% by weight,

Al₂O₃: 10 to 30% by weight,

CaO+MgO: 12 to 35% by weight,

Iron oxide: 2 to 10% by weight,

Na₂O+K₂O: 0 to 20% by weight.

The glass in the furnace generally has a temperature of greater than 1200° C. Furthermore, it generally has a temperature of less than 1700° C. If the glass has the composition of an alumina-rich glass wool as has just been given (composition C), then its temperature in the furnace is generally between 1350 and 1700° C. If the glass has the composition of a conventional glass wool (composition B), then its temperature in the furnace is generally between 1200 and 1420° C. In the device according to the invention, the highest temperature for the glass lies in the furnace and never after the barrier. The hottest point for the glass is thus in the furnace, opposite the upstream face of the barrier. This is because the device according to the invention is sufficiently efficient to melt the glass without it being necessary to provide a refining zone behind the barrier.

The temperature is advantageously sufficiently high for the viscosity η in poises of the glass at 1 cm from the upstream face of the barrier to be such that log₁₀ η<2. This relatively high temperature makes it possible to fluidify the glass, which in its turn makes possible the establishment of a strong convection current at the furnace outlet. This strong current, combined with the positioning of the upstream face of the barrier right in the convection current, prevents the formation of congealed glass on the upstream face of the barrier, for this reason eliminating the uncontrolled and undesired release of particles during manufacture. This viscosity is considered at a distance of 1 cm from the upstream face of the barrier towards the inside of the furnace, in the middle of the width of the barrier and at mid height of the depth of the barrier in contact with the glass.

The more the glass former absorbs IR radiation, the more the heat transfers are limited and the more a significant heat gradient is observed from the bottom to the crust of raw materials floating above the molten glass former. From up to 3% by weight of iron oxide, it is considered that the glass absorbs little infrared radiation and the temperature of the glass is substantially homogeneous in the furnace. The invention is particularly suitable for the melting of this type of glass having a low iron oxide content. In this case, the temperature of the glass in the furnace is generally between 1200 and 1400° C.

The feeding channel can feed in particular a device for the fiberizing of glass wool or a device for the manufacture of hollow glass, such as small or large bottles.

FIG. 1 represents a device according to the invention, top view.

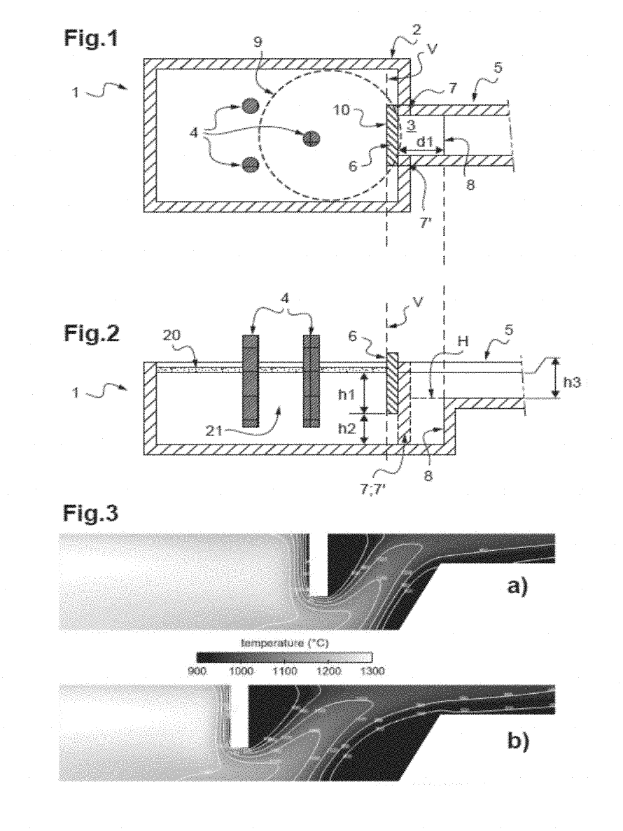

FIG. 2 represents the same device as that of FIG. 1, side view.

FIG. 3 represents a comparison of the distribution of the temperatures depending on whether the barrier is in the channel in a) or in the furnace in b).

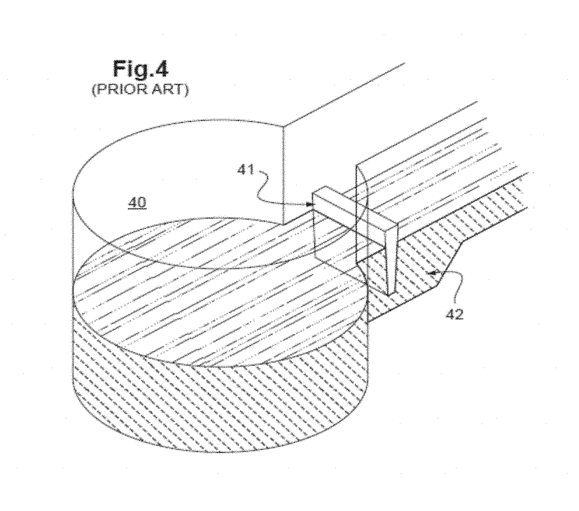

FIG. 4 represents a furnace according to WO2013/098504 in perspective.

The figures are not to scale.

FIG. 1 represents a device according to the invention, top view. It comprises a furnace 1, the side walls 2 of which form a rectangle seen from above. The furnace comprises a side opening 3. Molybdenum electrodes 4 dip into the vitrifiable materials via the top to heat the latter by the Joule effect. This opening is connected to a feeder channel 5. A barrier 6, placed in the furnace 1, dips into the glass via the top. This barrier has a greater width than that of the opening and is supported on the jambs 7 and 7′ of the walls. An upward step 8 at the beginning of the channel lowers the glass height when moving from the furnace to the channel. The step is at a distance d1 behind the barrier, d1 preferably being greater than 250 mm. The biggest circle 9 the most downstream of the furnace and being inscribed in the furnace seen from above, barrier excluded, is represented in dashes. This virtual circle touches the side walls and the two jambs on either side of the opening since, for the placing of this circle, the barrier is not taken into account. The upstream face 10 of the barrier is inside the circle 9. The vertical plane V passing through the upstream face 10 of the barrier indeed touches this circle 9 since it cuts it at two places. The barrier is in the furnace and rests on the side walls of the furnace on either side of the opening 3.

FIG. 2 represents the same device as that of FIG. 1, side view. The references shared with those of FIG. 1 denote the same components or characteristics. In the furnace 1, a crust of raw materials 20 which have not yet melted floats above the level of glass 21. The barrier dips into the glass by a depth h1 from the bottom of the crust of raw materials. The height of glass under the barrier is h2. The height h3 of glass in the channel is less than the height of molten glass h1+h2 in the furnace. The circle 9 of FIG. 1 occurs at the height of the highest side of the bottom of the channel 5, that is to say in the horizontal plane H of FIG. 2.

FIG. 3 represents a comparison of the distribution of the temperatures depending on whether the barrier is in the channel in a) or in the furnace in b). In these configurations a) and b), the side opening of the furnace is located at the level of the downstream face of the barrier positioned according to FIG. 3b). It is seen in particular that the face of the barrier turned towards the centre of the furnace (towards the left in the figures) is hotter in b) than in a). For these measurements, use was made of a furnace with a glass surface area of 2.5 m² operating with a draw of 6.2 tonnes per day. The glass comprised 65.7% of SiO₂, 17.1% of Na₂O+K₂O, 4.5% of B₂O₃, 2.05% of Al₂O₃, 8% of CaO and 2.5% of MgO. The bottom temperature was 1350° C.

FIG. 4 represents a furnace according to WO2013/098504, in perspective. Only the general formula is represented in order to show the place of the barrier. The furnace 40 is circular and the barrier 41, which is removable vertically, is located in the channel 42 so that the biggest horizontal circle which can be inscribed the furthest downstream in the furnace cannot touch the barrier. This biggest circle furthermore corresponds to the circular internal wall of the furnace. According to this arrangement, the barrier is in a fairly cold region and the barrier is not removable laterally. Consequently, it may happen that the barrier is blocked in the channel and very difficult to extricate.

1. A device for melting glass comprising:
a furnace equipped with electrodes in contact with a mass of vitrifiable materials, the furnace comprising a side opening connected to a feeder channel for the molten glass, a removable barrier dipping into the glass in or before the opening so that a vertical plane passing through an upstream face of the barrier touches a biggest horizontal circle which can be inscribed the furthest downstream in the furnace, barrier excluded, the biggest circle being at a height of a highest side of a bottom of the channel.

2. The device according to the claim 1, wherein the barrier is wider than the side opening of the furnace.

3. The device according to claim 1, wherein the barrier is in the furnace and is supported against side walls of the furnace on either side of the opening.

4. The device according to claim 1, wherein the barrier is removable vertically.

5. The device according to claim 1, wherein the barrier is removable laterally.

6. The device according to claim 1, wherein the barrier is in contact with side walls of the furnace or of the channel, forcing the molten glass to pass under the barrier without being able to pass through sides of the barrier.

7. The device according to claim 1, wherein, from passage of the glass under the barrier, the glass is in plug flow.

8. The device according to claim 1, wherein the electrodes are immersed in the glass via a top.

9. The device according to claim 1, wherein the barrier is wider than the side opening of the furnace and is in the furnace, supported against side walls of the furnace on either side of the opening, and is mobile laterally.

10. A process for preparing glass, comprising:
melting of vitrifiable materials by the device of claim 1.

11. The process according to claim 10, wherein the channel feeds a glass wool fiberizing device.

12. The process according to claim 10, wherein the glass comprises:
SiO₂: 35 to 80% by weight,
Al₂O₃: 0 to 30% by weight,
CaO+MgO: 5 to 35% by weight,
Na₂O+K₂O: 0 to 20% by weight.

13. The process according to claim 12, wherein SiO₂+Al₂O₃ is within a range extending from 50 to 80% by weight and Na₂O+K₂O+B₂O₃ is within a range extending from 5 to 30% by weight.

14. The process according to claim 10, wherein the glass comprises the following components:
SiO₂: 50 to 75% by weight,
Al₂O₃: 0 to 8% by weight,
CaO+MgO: 5 to 20% by weight,
Iron oxide: 0 to 3% by weight,
Na₂O+K₂O: 12 to 20% by weight,
B₂O₃: 2 to 10% by weight.

15. The process according to claim 10, wherein the glass comprises the following components:
SiO₂: 35 to 50% by weight,
Al₂O₃: 10 to 30% by weight,
CaO+MgO: 12 to 35% by weight,
Iron oxide: 2 to 10% by weight,
Na₂O+K₂O: 0 to 20% by weight.

16. The process according to claim 10, wherein a temperature of the glass is sufficiently high for a viscosity η in poises of the glass at 1 cm from the upstream face of the barrier to be such that log₁₀ η<2.

17. The process according to claim 10, wherein a temperature of the glass in the furnace is between 1200 and 1700° C.

18. The process according to claim 10, wherein a highest temperature of the glass is located in the furnace, opposite the upstream face of the barrier.

19. The process according to claim 10, wherein a draw is between 5 and 100 tonnes per day.

20. The process according to claim 10, wherein a height of glass under the barrier is less than a height of the barrier in contact with the molten glass under a crust of raw materials.
